(19) United States
(12) Patent Application Publication
(10) Pub. No.: US 2026/0008386 A1
(43) Pub. Date: Jan. 8, 2026

(54) Power Recliner Drive For A Vehicle Seat

(71) Applicant: Fisher & Company, Incorporated, St. Clair Shores, MI (US)

(72) Inventors: Mircea NAPAU, Sterling Heights, MI (US); Doina Napau, Sterling Heights, MI (US); Ileana Dacia Napau, Cugir (RO); Ioan Napau, Rochester Hills, MI (US); Ryan Martin, Macomb, MI (US); Sapan Mahendra Poptani, Northville, MI (US)

(73) Assignee: Fisher & Company, Incorporated, St. Clair Shores, MI (US)

(21) Appl. No.: 19/239,059

(22) Filed: Jun. 16, 2025

Related U.S. Application Data
(60) Provisional application No. 63/666,737, filed on Jul. 2, 2024.

(51) Int. Cl. B60N 2/22; B60N 2/225

(52) U.S. Cl. CPC B60N 2/2231; B60N 2/2251

(57) ABSTRACT

A power recliner drive for a vehicle seat includes a motor having an output shaft and a worm gear. A helical gear is meshingly engaged with the worm gear, the helical gear having an eccentric hub extending therefrom. A locking fork includes a guide slot movably received on a guide pin and a fork end having a pair of legs that straddle the eccentric hub of the helical gear, the pair of legs each including a drive slot. A planetary gear includes a pair of lugs each engaging a respective one of the drive slots of the pair of legs and including a first plurality of external gear teeth. An output gear includes a second plurality of internal gear teeth meshingly engaged by the first plurality of external gear teeth of the planetary gear, the output gear being configured to be connected to a shaft of a reclining seat back.

### CROSS-REFERENCE TO RELATED APPLICATIONS

This application claims the benefit of U.S. Provisional Application No. 63/666,737, filed on Jul. 2, 2024. The entire disclosure of the above application is incorporated herein by reference.

### FIELD

The present disclosure relates to a power recliner drive for a vehicle seat.

### BACKGROUND

This section provides background information related to the present disclosure and is not necessarily prior art.

Vehicle seats are commonly provided with recliner mechanisms. Many recliner mechanisms are mechanically operated by the seat passenger. Power recliner drive mechanisms are also provided with an electric motor and gear drive that can be operated by a switch to control recliner drive mechanism. A problem with the power recliner drive mechanisms is that they are susceptible to back drive.

Gear drive mechanisms used in automotive interior actuators can perform several useful functions: reduce or increase the speed, multiply or decrease the torque, and reverse the direction of rotation. In one example, automotive recliner mechanisms are gear drives that adjust a back seat position relative to a seat bottom. Power recliner mechanisms serve to adjust and secure the angular position of a vehicle back seat relative to the seat bottom, process in which the electric motor input speed is reduced while increasing its input torque. Some of the most important requirements for automotive recliner mechanisms include: the range of reduction ratio, the range of output torque, size, weight, efficiency, the level of noise produced by the recliner mechanism, shock load capability, cost, durability, packaging size, and the amount of backlash. For some applications, such as those used in adjusting and maintaining the angular adjusted position of a back seat relative to the seat bottom, a special requirement called anti-back drive capability is also required. The anti-back drive capability may also be referred to as “non-back drive capability,” “self-locking capability,” or “anti-regression capability.” Gear drives transfer the high speed and low torque rotation of an electric motor input shaft to low speed and high torque rotation of an output shaft, in either, a clockwise (CW) or a counter-clockwise (CCW) direction of rotation. For gear drives with anti-back drive capability, any attempt to transfer torque from the output shaft back to the input shaft by applying an external load to the output shaft (e.g. external reaction forces in the case of a crash accident, etc.) is prevented.

In addition, a reduction of free play can reduce the noise and vibration produced by the two gear elements and may improve the perceived quality of the rotary recliner mechanism. One way to reduce the backlash is to increase the manufacturing and assembly accuracy of the gear teeth elements, allowing the production of the gears with only the nominal value of the backlash necessary for operation. However, increasing manufacturing and assembly accuracy result in an undesirable increase in production and assembly costs of the gear sets.

### SUMMARY

This section provides a general summary of the disclosure and is not a comprehensive disclosure of its full scope or all of its features.

According to an aspect of the present disclosure, a power recliner drive for a vehicle seat includes a motor having an output shaft and a worm gear. A helical gear is meshingly engaged with the worm gear, the helical gear having an eccentric hub extending therefrom. A locking fork includes a guide slot movably received on a guide pin and a fork end having a pair of legs that straddle the eccentric hub of the helical gear, the pair of legs each including a drive slot. A planetary gear includes a pair of lugs each engaging a respective one of the drive slots of the pair of legs and including a first plurality of external gear teeth. An output gear includes a second plurality of internal gear teeth meshingly engaged by the first plurality of external gear teeth of the planetary gear, the first plurality of external gear teeth being smaller than the second plurality of internal gear teeth, the output gear being configured to be connected to a shaft of a reclining seat back.

According to a further aspect, the output gear includes a hub shaft that is rotatably supported within a housing.

According to a further aspect, the motor is mounted to the housing.

According to a further aspect, the guide pin is rotatably supported within the housing.

According to a further aspect, the first plurality of external gear teeth of the planetary gear and the second plurality of internal gear teeth of the output gear are conical involute teeth.

According to a further aspect, the first plurality of external gear teeth of the planetary gear and the second plurality of internal gear teeth of the output gear are biased toward one another with a spring.

According to another aspect of the present disclosure, a power recliner drive for a vehicle seat includes a motor having an output shaft and a worm gear. A face gear is meshingly engaged with the worm gear, the face gear having an eccentric hub extending therefrom. A locking fork includes a guide slot movably received on a guide pin and a fork end having a pair of legs that straddle the eccentric hub of the face gear. The pair of legs each include a drive slot. A planetary gear includes a pair of lugs each engaging a respective one of the drive slots of the pair of legs and including a first plurality of external gear teeth. An output gear includes a second plurality of internal gear teeth meshingly engaged by the first plurality of external gear teeth of the planetary gear. The first plurality of external gear teeth are smaller than the second plurality of internal gear teeth. The output gear is connected to a shaft of a reclining seat back.

According to a further aspect, a hub shaft that is rotatably supported within the housing.

According to a further aspect, the motor is mounted to the housing.

According to a further aspect, the guide pin is rotatably supported within the housing.

According to a further aspect, the first plurality of external gear teeth of the planetary gear and the second plurality of internal gear teeth of the output gear are conical involute teeth.

According to a further aspect, the first plurality of external gear teeth of the planetary gear and the second plurality of internal gear teeth of the output gear are biased toward one another with a spring.

According to another aspect of the present disclosure, a power recliner drive for a vehicle seat includes a motor having an output shaft and a worm gear. A helical gear is meshingly engaged with the worm gear, the helical gear including a pinion gear having a first plurality of conical gear teeth extending therefrom. An output gear includes a second plurality of conical involute gear teeth meshingly engaged by the first plurality of conical involute gear teeth of the pinion gear, the output gear being connected to a shaft of a reclining seat back.

According to a further aspect, the motor is mounted to the housing.

According to a further aspect, the pinion gear and the output gear are biased toward one another with a spring.

According to a further aspect, the worm gear is a dual lead worm.

According to a further aspect, the helical gear has helical conical involute teeth engaged with the dual lead worm.

According to a further aspect, a wavy spring biases the helical conical involute teeth into engagement with the dual lead worm.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1A is an exploded perspective view of a power recliner drive with anti-back drive capability for a vehicle seat according to the principles of the present disclosure;

FIG. 1B is an assembled view of the power recliner drive with the housing removed for showing the gear components is meshing engagement;

FIG. 1C is a cross-sectional view of the power recliner drive taken along line 1C-1C of FIG. 4;

FIG. 1D is a cross-sectional view of the power recliner drive taken along line 1D-1D of FIG. 4;

FIG. 2 is a front plan view of the power recliner drive with anti-back drive capability for a vehicle seat;

FIG. 3 is a top plan view of the power recliner drive with anti-back drive capability for a vehicle seat;

FIG. 4 is a rear plan view of the power recliner drive with anti-back drive capability for a vehicle seat;

FIG. 5 is an exploded perspective view of a power recliner drive with anti-back drive capability for a vehicle seat according to a second embodiment of the present disclosure;

FIG. 6 is an exploded perspective view of a power recliner drive for a vehicle seat according to a third embodiment of the present disclosure;

FIG. 7 is an exploded perspective view of a power recliner drive for a vehicle seat according to a fourth embodiment of the present disclosure;

FIG. 8 is an exploded perspective view of a power recliner drive for a vehicle seat according to a fifth embodiment of the present disclosure;

FIG. 9 is an exploded perspective view of a backlash-free power recliner drive for a vehicle seat according to a fifth embodiment of the present disclosure;

FIG. 10 is a detailed view of the helical involute teeth of the helical conical involute gear engaged with the dual lead worm;

FIG. 11 is a detailed view of the conical involute teeth of the output gear meshingly engaged with the helical conical involute teeth of the pinion gear; and

FIG. 12 is a schematic view of a vehicle seat having a seat back driven by a power recliner drive according to the principles of the present disclosure.

Corresponding reference numerals indicate corresponding parts throughout the several views of the drawings.

### DETAILED DESCRIPTION

Example embodiments will now be described more fully with reference to the accompanying drawings.

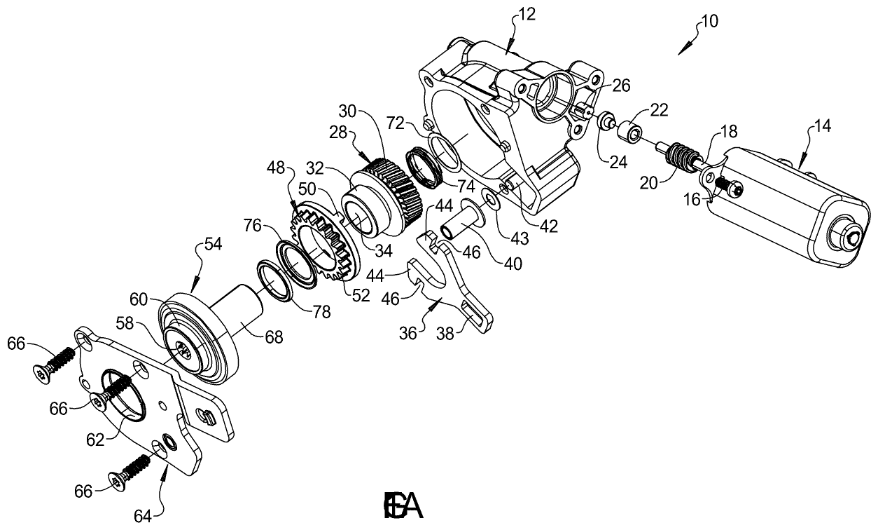

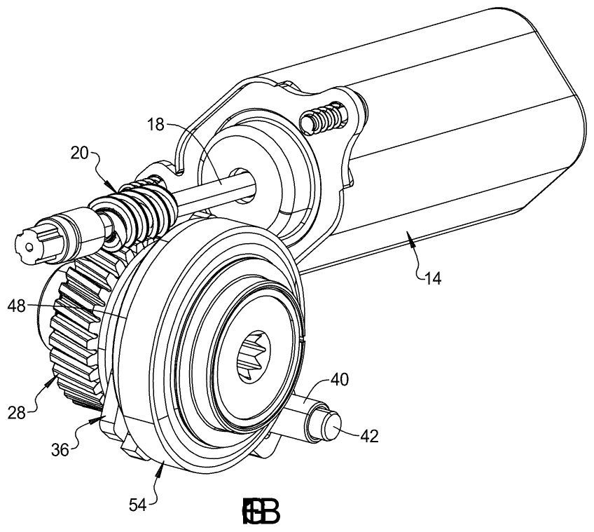

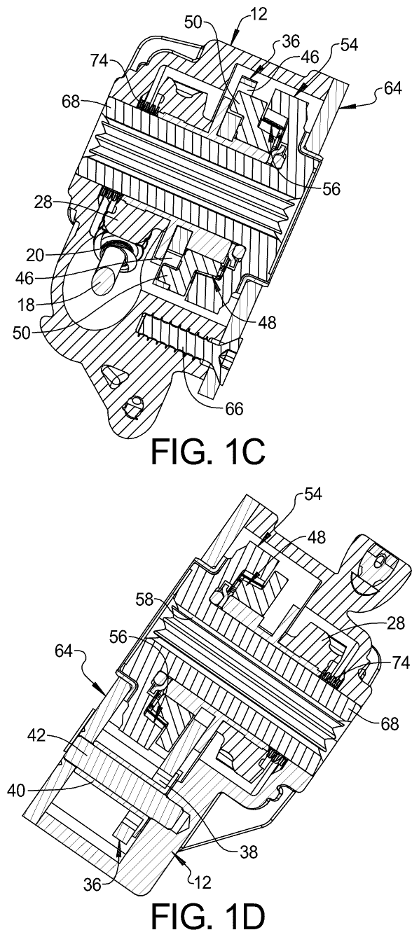

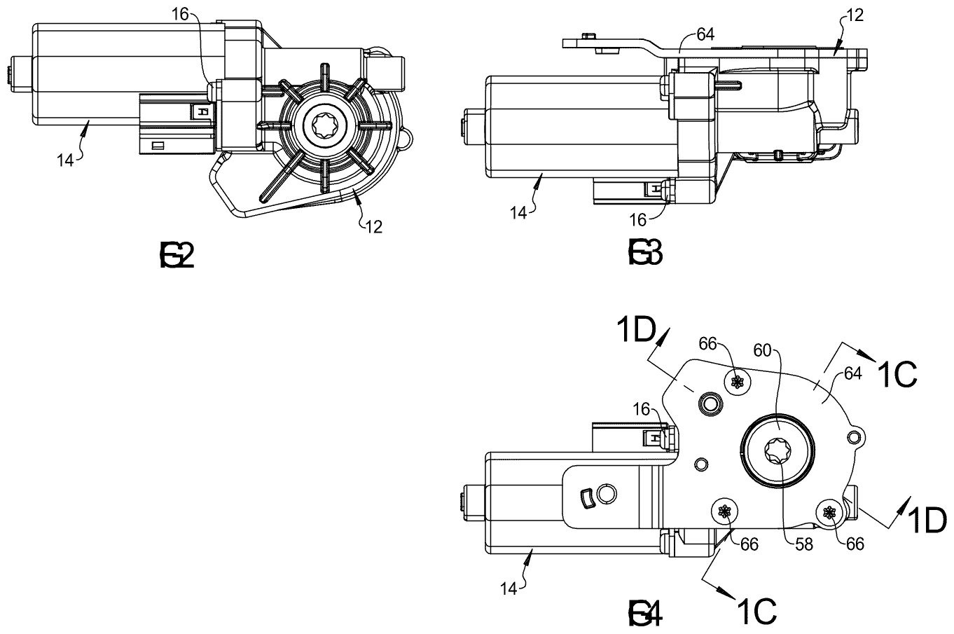

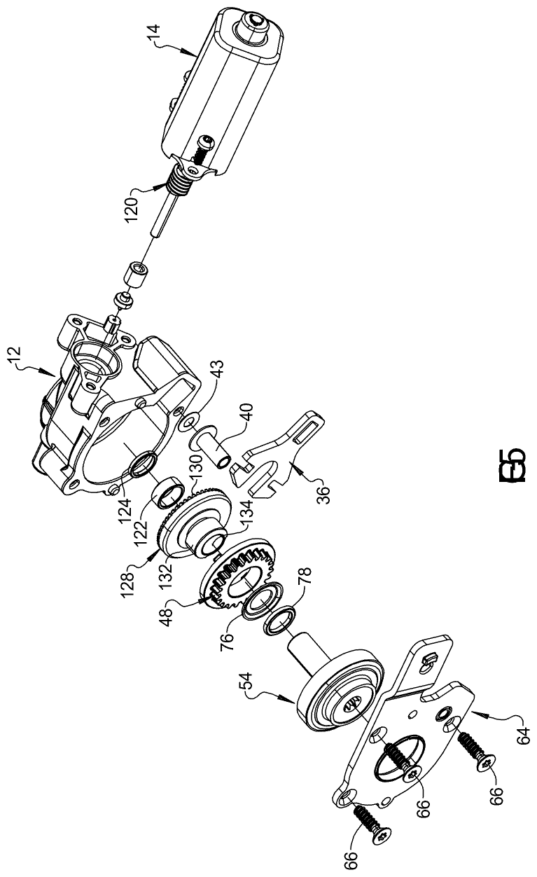

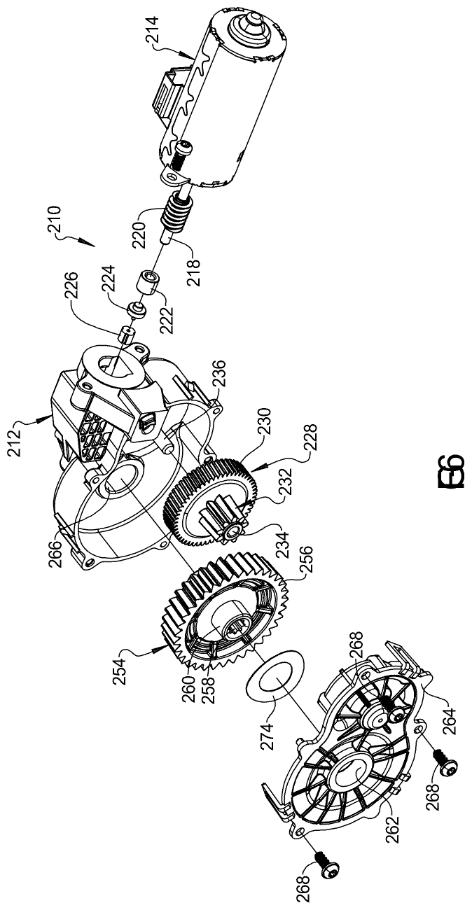

With reference to FIGS. 1A-4, a power recliner drive 10 for a vehicle seat includes a housing 12. A motor 14 can be mounted to the housing 12 by a plurality of screws 16. The motor 14 includes a drive shaft 18 having a worm 20. A distal end of the drive shaft 18 is supported within the housing by a bearing bushing 22. A compression shaft 24 and a rubber or elastic buffer 26 are provided to absorb axial force of the drive shaft 18.

A helical gear 28 is rotatably supported within the housing 12 and includes a plurality of helical teeth 30 (thirty-one (31) are shown) in meshing engagement with the worm 20. The helical gear 28 includes an eccentric hub 32 and a bore 34 extending therethrough. A locking fork 36 includes a first end with a guide slot 38 movably received on a guide pin 40 (see FIG. 1D) that is rotatably mounted within the housing 12 on a pin guide 42. A friction reducing washer 43 is disposed between the housing 12 and the guide pin 40. The locking fork 36 includes a fork end having a pair of legs 44 that straddle the eccentric hub 32 of the helical gear 28. The pair of legs 44 each include a drive slot 46.

AS best shown in FIG. 1C, a planetary gear 48 includes a pair of lugs 50 each engaging a respective one of the drive slots 46 of the pair of legs 44 of the locking fork 36. The planetary gear 48 includes a first plurality of external conical involute gear teeth 52 (twenty (20) are shown).

An output gear 54 includes a second plurality of internal conical involute gear teeth 56 (best shown in FIGS. 1C and 1D, the configuration shown in FIGS. 1A-4 has twenty-one (21) teeth 56) meshingly engaged by the first plurality of external conical involute gear teeth 52 of the planetary gear 48. The number of the first plurality of external conical involute gear teeth of the planetary gear 48 is smaller than the number of the second plurality of internal conical involute gear teeth 56 of the output gear 54. The output gear 54 includes an internal spline 58 that is configured to be connected to a shaft of a reclining seat back (not shown). The output gear 54 includes a first bearing hub shaft 60 rotatably supported within a bearing bushing 62 received in a cover 64 that is mounted to the housing 12 by fasteners 66. The output gear 54 includes a second bearing shaft 68 that extends through the bore in the planetary gear 48 and the helical gear 28 and is rotatably supported in the housing 12. A metal ring 72 provides a bearing surface for a wavy spring 74 that applies a biasing force against the helical gear 28 and the planetary gear 48 toward the output gear 54. A friction plate 74 and a rubber or elastic dumper ring 76 compensate for axial play between the planetary gear 48 and the output gear 54. FIG. 1B shows the power recliner drive 10 in an assembled condition with the cover 64 removed for showing the worm 20 and helical gear 28 in meshing engagement and with the planetary gear 48 and the output gear 54 in meshing engagement.

The power recliner drive 10 as shown in FIGS. 1-4 is designed with a drive gear ratio of 325.5:1 that provides high torque and provides a reliable anti-back drive capability for the power recliner. Alternative gear arrangements can be provided to include different drive gear ratios. The drive ratios can be selected to provide high speed, comfort speed or high torque as desired for a particular application. The conical involute teeth of the planetary gear 48 and the output gear 54 provide reduced noise for the gear drive system.

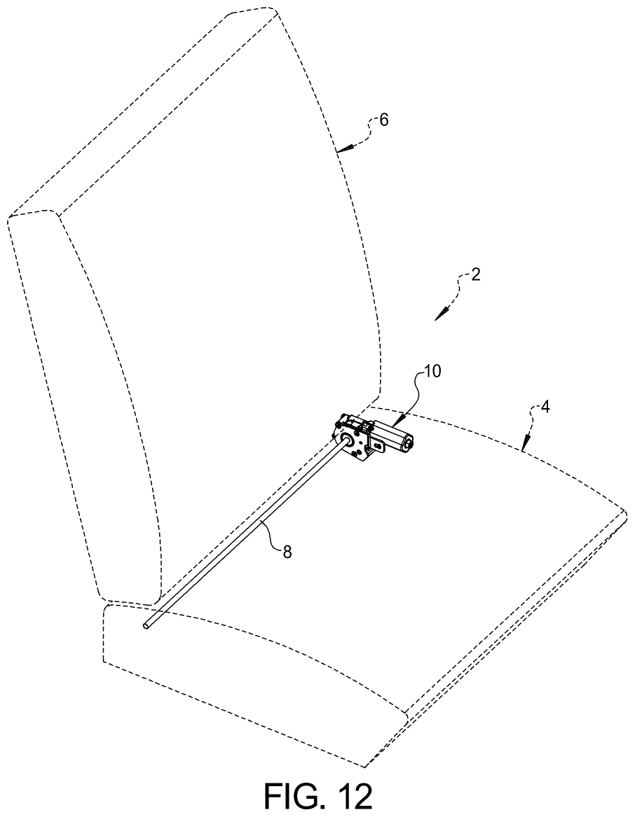

FIG. 12 is a schematic view of the vehicle seat 2 having a seat bottom 4 and a reclining seat back 6 and having a power recliner drive 10 connected to a shaft 8 of the seat back 6.

As shown in FIGS. 5, the helical gear 28 can be replaced with a face gear 128 having a plurality of face teeth that engage the worm 120. A distance bushing 122 and a metal ring 124 are disposed between the face gear 128 and the housing 112 to provide proper spacing of the face gear 128 with the worm 120. The metal ring 124 reduces friction between the distance bushing 122 and the housing 112. The face gear 128 is rotatably supported within the housing 112 and includes a plurality of face teeth 30 (forty-nine (49) are shown) in meshing engagement with the worm 120. The face gear 128 includes an eccentric hub 132 and a bore 134 extending therethrough. The remaining drive system is the same as described with reference to FIG. 1 and the same reference numerals are used therein.

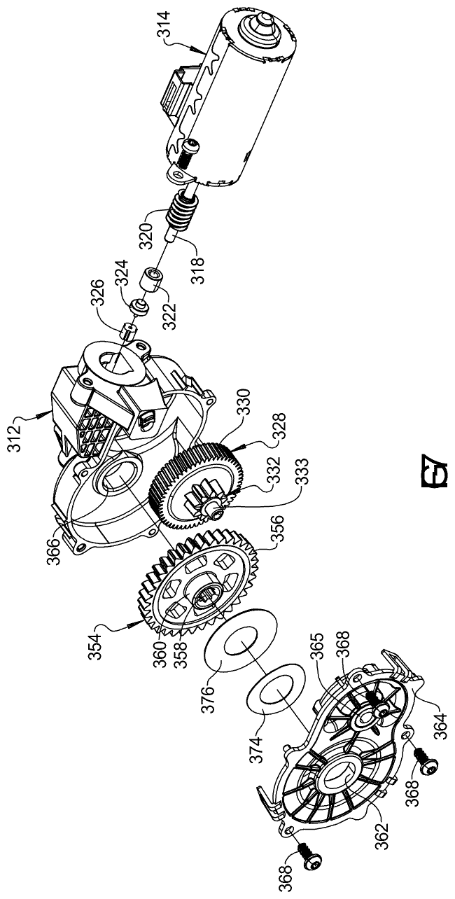

With reference to FIG. 6, an alternative power recliner drive 210 for a vehicle seat includes a housing 212. A motor 214 can be mounted to the housing 212 by a plurality of screws 216. The motor 214 includes a drive shaft 218 having a worm 220. A distal end of the drive shaft 218 is supported within the housing 212 by a bearing bushing 222. A compression shaft 224 and a rubber or elastic buffer 226 are provided to absorb axial force of the drive shaft 218.

A helical gear 228 is rotatably supported within the housing 212 and includes a plurality of helical teeth 230 (forty-one (41) are shown) in meshing engagement with the worm 220. The number of helical teeth 230 The helical gear 228 includes a pinion gear 232 rotatably fixed thereto. The pinion gear 232 as shown includes 8 conical involute teeth. The pinion gear 232 can be formed from powder metal or can be machined from a metal blank. The helical gear 228 can be molded from plastic and can be molded onto the pinion gear 232. The pinion gear 232 includes a bore 234 extending therethrough. The pinion gear 232 is rotatably supported on a shaft 236 that is supported by the housing 212. The shaft 236 can include a knurled end that can be press fit into a bore in the housing 212.

An output gear 254 includes a second plurality of conical involute teeth 256 (forty-seven (47) are shown) meshingly engaged with the conical involute teeth of the pinion gear 232. The number of the conical involute teeth of the pinion gear 232 is smaller than the number of the conical involute teeth of the output gear 254. The output gear 254 includes internal splines 258 that are configured to be connected to a shaft of a reclining seat back. The output gear 254 includes a first bearing hub shaft 260 rotatably supported within a bearing bushing 262 of a cover 264 and a bearing bushing 266 of the housing 212. The output gear 254 can be made from plastic and can be molded as one-piece. The cover 264 is secured to the housing 212 by fasteners 268. A wavy spring 274 applies a biasing force to the output gear 254 to cause tight engagement between the conical involute teeth of the output gear 254 and the conical involute teeth of the pinion gear 232 in order to prevent free play between the gear teeth. The wavy spring 274 can be made from a spring material such as metal.

The power recliner drive 210 as shown in FIG. 6 has a drive gear ratio of 241:1 that provides a comfortable reclining speed and high torque for the seat reclining mechanism. The conical involute teeth of the pinion gear 232 and the output gear 254 provide for elimination of free play and reduced noise for the gear drive system. Alternative gear arrangements can be provided to include different drive gear ratios.

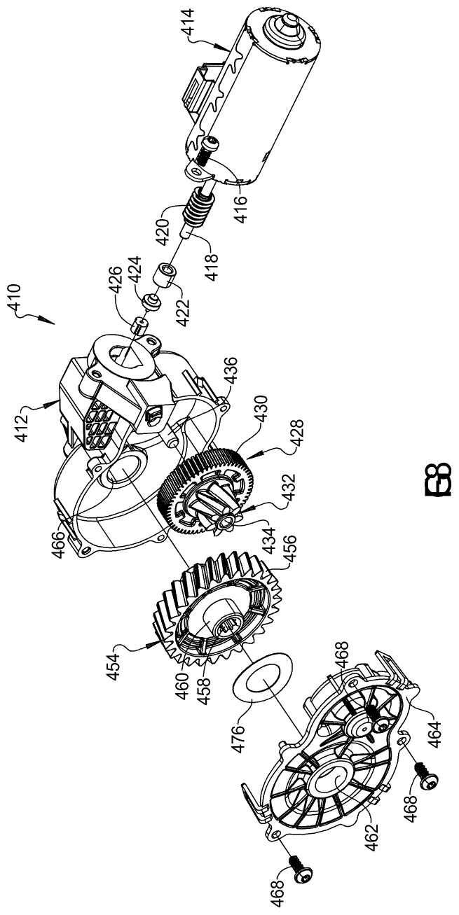

With reference to FIG. 7, an alternative power recliner drive 310 for a vehicle seat includes a housing 312 that includes a thinner profile than the housing 212 of the embodiment of FIG. 6. A motor 314 can be mounted to the housing 312 by a plurality of screws 316. The motor 314 includes a drive shaft 318 having a worm 320. A distal end of the drive shaft 318 is supported within the housing 312 by a bearing bushing 322. A compression shaft 324 and a rubber or elastic buffer 326 are provided to absorb axial force of the drive shaft 318.

A helical gear 328 is rotatably supported within the housing 312 and includes a plurality of helical teeth 330 (in order to provide the drive 310 with essentially an anti-back drive system, 50 or more teeth can be used) in meshing engagement with the worm 320. The helical gear 328 includes a pinion gear 332 rotatably fixed thereto. The pinion gear 332 as shown includes 8 conical involute teeth although other numbers of teeth can be used. The helical gear 328 and pinion gear 332 can both be made from powder metal. The helical gear 328 and pinion gear 332 include a shaft extension 333 extending from opposite sides (one is shown) that are received in corresponding bearing bushings 365 (one is shown) in the housing 312 and cover 364.

An output gear 354 includes a second plurality of conical involute teeth 356 (forty-seven (47) are shown) meshingly engaged with the conical involute teeth of the pinion gear 332. The number of the conical involute teeth of the pinion gear 332 is smaller than the number of the conical involute teeth of the output gear 354. The output gear 354 can be made from powder metal to allow the output gear 354 to be made thinner and still withstand the necessary torque loads. The thinner output gear 354 allows the housing 312 to be made smaller. The output gear 354 includes internal splines 358 that are configured to be connected to a shaft of a reclining seat back. The output gear 354 includes a first bearing hub shaft 360 rotatably supported within a bearing bushing 362 of a cover 364 and a bearing bushing 366 of the housing 312. The cover 364 is secured to the housing 312 by fasteners 368. A wavy spring 374 and a friction plate 376 apply a biasing force to the output gear 354 to cause tight engagement between the conical involute teeth of the output gear 354 and the conical involute teeth of the pinion gear 332 in order to prevent free play between the gear teeth. The friction plate 376 can be made from plastic and reduces friction and noise.

The power recliner drive 310 as shown in FIG. 7 has a drive gear ratio of 241:1 that provides a comfortable reclining speed and high torque for the seat reclining mechanism. The conical involute teeth of the pinion gear 332 and the output gear 354 provide for elimination of free play and reduced noise for the gear drive system. Alternative gear arrangements can be provided to include different drive gear ratios.

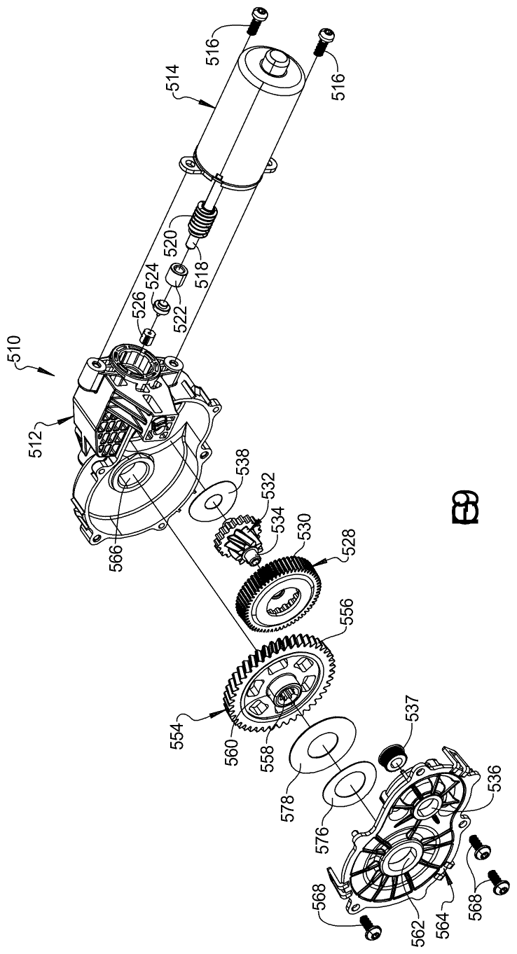

With reference to FIG. 8, an alternative power recliner drive 410 for a vehicle seat includes a housing 412. A motor 414 can be mounted to the housing 412 by a plurality of screws 416. The motor 414 includes a drive shaft 418 having a worm 420. A distal end of the drive shaft 418 is supported within the housing 412 by a bearing bushing 422. A compression shaft 424 and a rubber or elastic buffer 426 are provided to absorb axial force of the drive shaft 418.

A helical gear 428 is rotatably supported within the housing 412 and includes a plurality of helical teeth 430 (forty-one (41) are shown) in meshing engagement with the worm 420. The helical gear 428 includes a pinion gear 432 rotatably fixed thereto. The pinion gear 432 as shown includes 7 helical conical involute teeth. The helical gear 428 and the pinion gear 432 can be made as one-piece from powder metal or made separately from a combination of powder metal and molded plastic. The pinion gear 432 includes a bore 434 extending therethrough. The helical gear 428 and the pinion gear 432 are rotatably supported on a shaft 436 that is supported by the housing 412. The shaft 436 can include a knurled end that can be press fit into a bore in the housing 412.

An output gear 454 includes a second plurality of helical conical involute teeth 456 (forty-seven (47) are shown) meshingly engaged with the conical involute teeth of the pinion gear 432. The number of the helical conical involute teeth of the pinion gear 432 is smaller than the number of the helical conical involute teeth of the output gear 454. The output gear 454 includes internal splines 458 that are configured to be connected to a shaft of a reclining seat back. The output gear 454 includes a first bearing hub shaft 460 rotatably supported within a bearing bushing 462 of a cover 464 and a bearing bushing 466 of the housing 412. The output gear 454 can be made from plastic or powder metal. The cover 464 is secured to the housing 412 by fasteners 468. A wavy spring 476 applies a biasing force to the output gear 454 to cause tight engagement between the helical conical involute teeth of the output gear 454 and the helical conical involute teeth of the pinion gear 432 in order to prevent free play between the gear teeth. The wavy spring 476 can be made from spring steel.

The power recliner drive 410 as shown in FIG. 8 has a drive gear ratio of 241:1 that provides a comfortable reclining speed and high torque for the seat reclining mechanism. The helical conical involute teeth of the pinion gear 432 and the output gear 454 provide for elimination of free play and reduced noise for the gear drive system. Alternative gear arrangements can be provided to include different drive gear ratios.

With reference to FIG. 9, an alternative power recliner drive 510 for a vehicle seat includes a housing 512. A motor 514 can be mounted to the housing 512 by a plurality of screws 516. The motor 514 includes a drive shaft 518 having a dual lead worm 520. A distal end of the drive shaft 518 is supported within the housing 512 by a bearing bushing 522. A compression shaft 524 and a rubber or elastic buffer 526 are provided to absorb axial force of the drive shaft 518. The worm 520 can be made from steel.

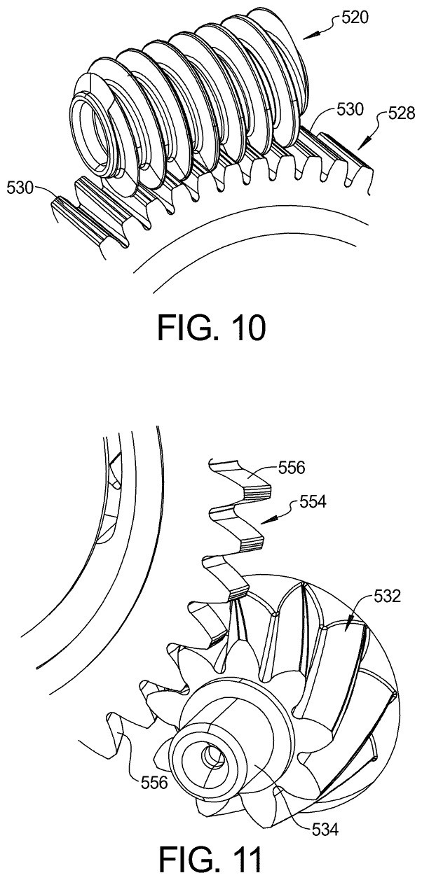

A helical conical involute gear 528 is rotatably supported within the housing 512 and includes a plurality of helical conical involute teeth 530 (fifty-seven (57) are shown) in meshing engagement with the dual lead worm 520. The helical conical involute gear 528 includes a helical conical involute pinion gear 532 rotatably fixed thereto. The helical conical involute pinion gear 532 as shown includes nine (9) helical conical involute teeth. The helical conical involute gear 528 and the helical conical involute pinion gear 532 can be made as one-piece from powder metal or made separately from a combination of powder metal (pinion gear 532) and over-molded plastic (helical gear 528). The pinion gear 532 includes a pair of hubs 534 extending from opposite ends that are supported within bores 536 in the housing 512. A bushing 537 can be used to support the hubs 534. A wavy spring 538 is provided between the helical conical involute gear 528 and the housing 512 to bias the conical involute teeth 530 into engagement with the dual lead worm 520 to prevent free play between the gear teeth. FIG. 10 provides a detail view of the helical conical involute teeth of the helical conical involute gear 528 engaged with the dual lead worm 520.

An output gear 554 includes a second plurality of helical conical involute teeth 556 (forty-three (43) are shown) meshingly engaged with the conical involute teeth of the pinion gear 532. FIG. 11 shows helical conical involute teeth 556 of the output gear 554 meshingly engaged with the helical conical involute teeth of the pinion gear 532. The number of the helical conical involute teeth of the pinion gear 532 is smaller than the number of the helical conical involute teeth of the output gear 554. The output gear 554 includes internal splines 558 that are configured to be connected to a shaft of a reclining seat back. The output gear 554 includes a first bearing hub shaft 560 rotatably supported within a bearing bushing 562 of a cover 564 and a bearing bushing 566 of the housing 512. The output gear 554 can be made from powder metal. The cover 564 is secured to the housing 512 by fasteners 568. A wavy spring 576 and friction ring 578 apply a biasing force to the output gear 554 to cause tight engagement between the helical conical involute teeth of the output gear 554 and the helical conical involute teeth of the pinion gear 532 in order to prevent free play between the gear teeth. The wavy spring 576 can be made from spring steel.

The power recliner drive 510 as shown in FIG. 9 is backlash-free and has a drive gear ratio of 272.3:1 that provides a comfortable reclining speed and high torque for the seat reclining mechanism. The helical conical involute teeth of the helical conical involute gear 428, the pinion gear 532 and the output gear 554 provide for elimination of free play and reduced noise for the gear drive system. Alternative gear arrangements can be provided to include different drive gear ratios.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power recliner drive for a vehicle seat, comprising:
a motor having an output shaft and a worm gear;
a helical gear meshingly engaged with the worm gear, the helical gear having an eccentric hub extending therefrom;
a locking fork having a guide slot movably received on a guide pin and a fork end having a pair of legs that straddle the eccentric hub of the helical gear, the pair of legs each including a drive slot;
a planetary gear having a pair of lugs each engaging a respective one of the drive slots of the pair of legs and including a first plurality of external gear teeth; and
an output gear having a second plurality of internal gear teeth meshingly engaged by the first plurality of external gear teeth of the planetary gear, the first plurality of external gear teeth being smaller than the second plurality of internal gear teeth, the output gear being configured to be connected to a shaft of a reclining seat back.

2. The power recliner drive of claim 1, further comprising a housing wherein the output gear includes a hub shaft that is rotatably supported within the housing.

3. The power recliner drive of claim 2, wherein the motor is mounted to the housing.

4. The power recliner drive of claim 2, wherein the guide pin is rotatably supported within the housing.

5. The power recliner drive of claim 1, wherein the first plurality of external gear teeth of the planetary gear and the second plurality of internal gear teeth of the output gear are conical involute teeth.

6. The power recliner drive of claim 1, wherein the first plurality of external gear teeth of the planetary gear and the second plurality of internal gear teeth of the output gear are biased toward one another with a spring.

7. A power recliner drive for a vehicle seat, comprising:
a motor having an output shaft and a worm gear;
a face gear meshingly engaged with the worm gear, the face gear having an eccentric hub extending therefrom;
a locking fork having a guide slot movably received on a guide pin and a fork end having a pair of legs that straddle the eccentric hub of the face gear, the pair of legs each including a drive slot;
a planetary gear having a pair of lugs each engaging a respective one of the drive slots of the pair of legs and including a first plurality of external gear teeth; and
an output gear having a second plurality of internal gear teeth meshingly engaged by the first plurality of external gear teeth of the planetary gear, the first plurality of external gear teeth being smaller than the second plurality of internal gear teeth, the output gear being connected to a shaft of a reclining seat back.

8. The power recliner drive of claim 7, further comprising a housing wherein the output gear includes a hub shaft that is rotatably supported within the housing, wherein the motor is mounted to the housing.

9. The power recliner drive of claim 8, wherein the guide pin is rotatably supported within the housing.

10. The power recliner drive of claim 7, wherein the first plurality of external gear teeth of the planetary gear and the second plurality of internal gear teeth of the output gear are conical involute teeth.

11. The power recliner drive of claim 8, wherein the first plurality of external gear teeth of the planetary gear and the second plurality of internal gear teeth of the output gear are biased toward one another with a spring.

12. A power recliner drive for a vehicle seat, comprising:
a motor having an output shaft and a worm gear;
a helical gear meshingly engaged with the worm gear, the helical gear having a pinion gear having a first plurality of conical involute gear teeth extending therefrom; and
an output gear having a second plurality of conical involute gear teeth meshingly engaged by the first plurality of conical involute gear teeth of the pinion gear, the output gear being connected to a shaft of a reclining seat back, wherein the pinion gear and the output gear are biased toward one another with a first spring.

13. The power recliner drive of claim 12, further comprising a housing wherein the output gear includes a hub shaft that is rotatably supported within the housing.

14. The power recliner drive of claim 13, wherein the motor is mounted to the housing.

15. The power recliner drive of claim 13, wherein the first spring is a wavy spring, and wherein the power recliner drive further comprises a plastic friction plate disposed between the wavy spring and the output gear.

16. The power recliner drive of claim 12, wherein the first plurality of conical involute teeth and the second plurality of conical involute teeth are helical.

17. The power recliner drive of claim 12, wherein the worm gear is a dual lead worm.

18. The power recliner drive of claim 17, wherein the helical gear has helical conical involute teeth engaged with the dual lead worm.

19. The power recliner drive of claim 18, further comprising a second spring that biases the helical conical involute teeth into engagement with the dual lead worm.

20. The power recliner drive of claim 19, wherein the second spring is a wavy spring.
